(19) United States
(12) Patent Application Publication
(10) Pub. No.: US 2015/0063732 A1
(43) Pub. Date: Mar. 5, 2015

(54) BEARING ELEMENT

(71) Applicant: Dr. Ing. h.c. F. Porsche Aktiengesellschaft, Stuttgart (DE)

(72) Inventors: Stefan Zeretzke, Auma (DE); Sebastian Huber, Heimerdingen (DE)

(21) Appl. No.: 14/468,681

(22) Filed: Aug. 26, 2014

(30) Foreign Application Priority Data
Aug. 27, 2013 (DE) 102013109257.8

(51) Int. Cl. F16C 35/02

(52) U.S. Cl. CPC F16C 35/02
USPC 384/276

(57) ABSTRACT

A bearing element having a bearing core and having a bearing sleeve, wherein a bearing body is arranged between the bearing core and the bearing sleeve and wherein a protective cap protects the bearing body against environmental influences. To reliably fix the protective cap to the bearing element, that the protective cap is fixed by a closure part, wherein the closure part engages around the bearing element and is formed by two half-shells which are of substantially symmetrical form, wherein the closure part both engages around the bearing element and also surrounds at least one section of a control linkage of a running gear of a motor vehicle and protects said section against high temperatures.

### CROSS-REFERENCE TO RELATED APPLICATIONS

This application claims priority under 35 U.S.C. §119 to German Patent Application No. DE 10 2013 109 257.8, filed Aug. 27, 2014, which is incorporated by reference herein it is entirety.

### FIELD OF THE INVENTION

The present invention relates to a bearing element having a bearing core and having a bearing sleeve, wherein a bearing body is arranged between the bearing core and the bearing sleeve and wherein a protective cap protects the bearing body against environmental influences.

### BACKGROUND OF THE INVENTION

DE 10 2008 045 158 A1, which is incorporated by reference herein, discloses a bearing element of the generic type mentioned in the introduction. The already known bearing element has a protective cap which protects the bearing body against environmental influences. Damaging environmental influences include inter alia thermal loading, and exposure to spray water, which can adversely affect the corrosion of the bearing body.

Furthermore, owing to excessively high exit air temperatures of the engine cooling arrangement, heating of the bearing element occurs, which shortens the service life of the bearing element. A protective cap of said type must therefore reliably protect the bearing element, wherein the assembly process should not be excessively cumbersome.

### SUMMARY OF THE INVENTION

It is therefore an object of the present invention to improve a bearing element of the generic type mentioned in the introduction such that the protective cap remains reliably in its installation position over the service life of the bearing element, and such that, at the same time, the assembly process is simplified.

Said object is achieved, according to aspects of the invention, by means of a bearing element having a bearing element having a bearing core and bearing sleeve, wherein a bearing body is arranged between the bearing core and the bearing sleeve and wherein a protective cap protects the bearing body against environmental influences, wherein the protective cap is fixed by a closure part, and wherein the closure part engages around the bearing element. Advantageous refinements of the subject matter of the invention are set forth in the detailed description following. It is provided here that the protective cap is fixed by a closure part, wherein the closure part engages around the bearing element.

One particularly advantageous refinement of the subject matter of the invention provides that the closure part is formed by two half-shells which are of substantially symmetrical form, wherein one half-shell is formed with detent elements which interact with corresponding recesses on the other half-shell so as to realize a locking action. By means of said measure, the protective caps are prevented from sliding off laterally by virtue of the lateral protective cap being clamped between the bearing sleeve and the closure part.

One advantageous refinement of the subject matter of the invention provides that the closure part both engages around the bearing element and also surrounds at least one section of a control linkage of a running gear of a motor vehicle and protects said section of the control linkage against high temperatures. In this way, said section of the control linkage is also protected against the high exit air temperatures of the engine cooling arrangement of the internal combustion engine, and the heat is prevented in an effective manner from propagating from the control linkage to the bearing element. For this purpose, it is provided that the closure part is produced from a heat-resistant plastic.

The protective cap is likewise formed from a temperature-resistant material. Ethylene propylene diene monomer rubber is provided as a temperature-resistant material.

### BRIEF DESCRIPTION OF THE DRAWINGS

The present invention will be explained in more detail, within the context of an exemplary embodiment, in conjunction with the appended drawing, in which:

FIG. 1 shows a control linkage with a bearing element, in a three-dimensional view, and

FIG. 2 shows a detail of the control linkage illustrated in FIG. 1, with bearing element, in a sectional illustration.

### DETAILED DESCRIPTION OF THE INVENTION

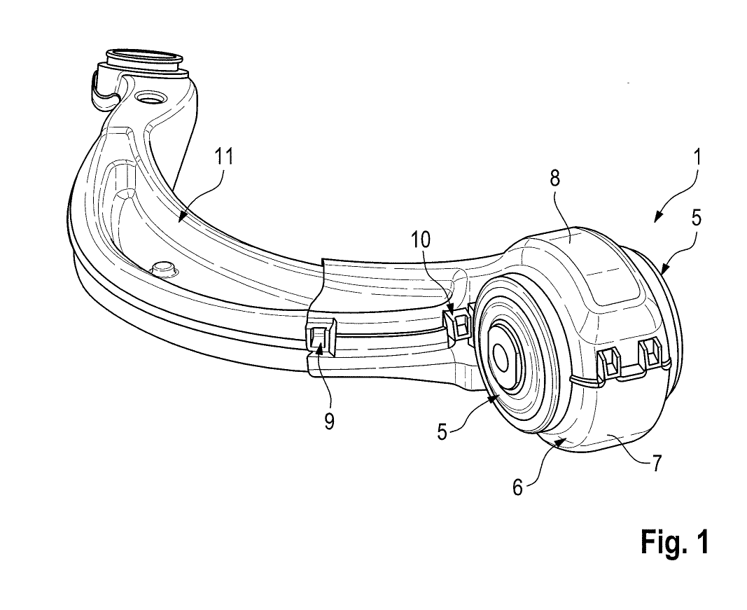

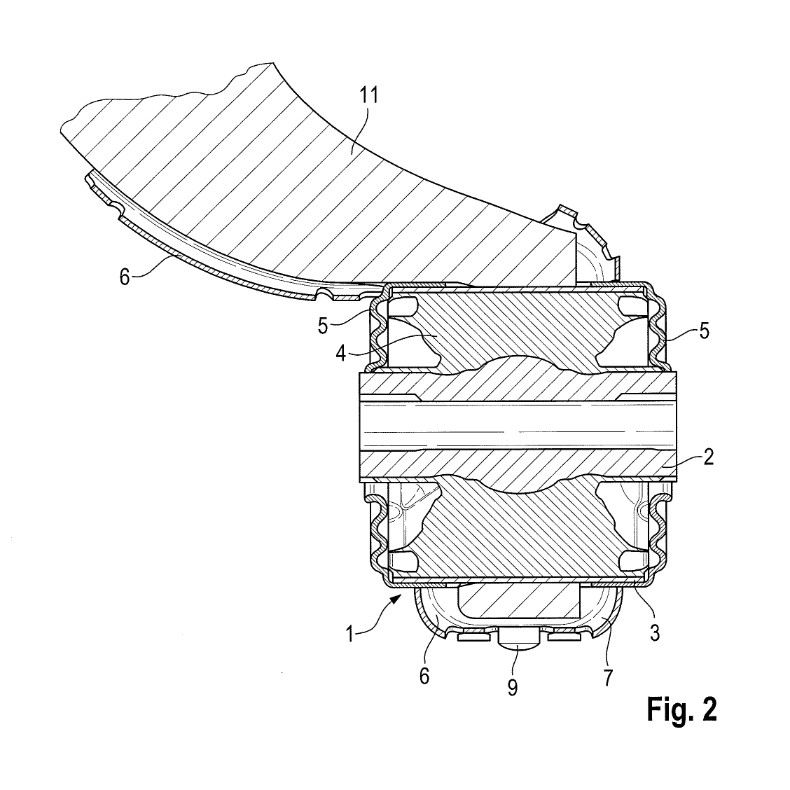

FIG. 1 illustrates a control linkage 11 of a running gear of a motor vehicle. Said control linkage is a transverse link 11 of the running gear of a motor vehicle. As can be seen from FIG. 1, the transverse link 11 has a bearing element 1 which may be in the form of a rubber bearing or in the form of a hydrodynamic plain bearing. To protect the bearing element 1 against environmental influences and in particular against high exit air temperatures of the cooling arrangement of an internal combustion engine, there is provided on each side of the bearing element 1 a protective cap 5 which is formed from a temperature-resistant material. Here, as a temperature-resistant material, use may be made of ethylene propylene diene monomer rubber, also known as EPDM. The bearing element is protected in a reliable manner by the two protective caps 5, as will be explained in yet more detail on the basis of FIG. 2.

It can also be seen from FIG. 1 that the protective caps 5 are fixed by a closure part 6, wherein the closure part 6 is designed so as to engage around the bearing element 1 and around a section of the transverse link 11. The closure part 6 is composed of two half-shells 7, 8 which are of substantially symmetrical form. Here, the lower half-shell 7 in FIG. 1 has detent elements 9 which are for example in the form of detent lugs. The upper half-shell 8 in FIG. 1 is formed with pocket-like recesses 10 into which or behind which the detent elements 9 can engage in order to realize a locking action. For the assembly of the closure part 6, therefore, the lower half-shell 7 and the upper half-shell 8 are arranged around the transverse link 11 and around the bearing element together with the two protective caps 5 and are pressed together in a simple assembly step, which gives rise to a locking action between the two half-shells 7, 8. It is ensured in this way that the protective caps 5 are reliably fixed and, at the same time, the closure part 6 also affords protection against excessively high temperatures to a section of the transverse link 11, because the closure part 6 is produced from a heat-resistant plastic. In this way, the protected section of the transverse link 11 cannot be heated to an excessive degree, and a transmission of heat from the heated transverse link 11 to the bearing element 1 is prevented.

FIG. 2 shows a sectional illustration of the bearing element 1 and of the transverse link 11. As can be seen from FIG. 2, the bearing element 1 is formed from a bearing core 2 and from a bearing sleeve 3, wherein a bearing body 4 is arranged between the bearing core 2 and the bearing sleeve 3. The bearing body 4 in particular must in this case be protected against environmental influences and in particular against exposure to excessively high temperatures. This is realized by means of the protective cap 5 which is arranged on both sides of the bearing element 1. As already mentioned, the protective caps 5 are fixed by a closure part 6, wherein the lower half-shell 7 is illustrated in FIG. 2. A detent element 9 of the lower half-shell 7 is illustrated in the lower region of FIG. 2. As can also be seen from FIG. 2, the closure part 6 engages around the bearing element 1 and clamps the protective cap 5 between the bearing sleeve 3 and the closure part 6. In this way, the protective caps 5 are prevented from sliding off laterally. As can also be seen from FIG. 2, the closure part 6 also extends over a section of the transverse link 11 and protects said section of the transverse link 11 against excessively high temperatures.

By means of the present invention, the protective caps 5 are reliably fixed to the bearing element 1, and the assembly process of the protective caps 5 is particularly simple owing to the construction of the closure part 6 with the two half-shells 7, 8.

What is claimed is:

1. A bearing element having a bearing core and having a bearing sleeve, wherein a bearing body is arranged between the bearing core and the bearing sleeve and wherein a protective cap protects the bearing body against environmental influences, wherein the protective cap is fixed by a closure part, and wherein the closure part engages around the bearing element.

2. The bearing element as claimed in claim 1, wherein the closure part is formed by two half-shells which are of substantially symmetrical form, wherein one half-shell is formed with detent elements which interact with corresponding recesses on the other half-shell so as to realize a locking action.

3. The bearing element as claimed in claim 1, wherein the closure part both engages around the bearing element and also surrounds at least one section of a control linkage of a running gear of a motor vehicle and protects said section against high temperatures.

4. The bearing element as claimed in claim 1, wherein the closure part is produced from a heat-resistant plastic.

5. The bearing element as claimed in claim 1, wherein the protective cap is formed from a temperature-resistant material.

6. The bearing element as claimed in claim 5, wherein the protective cap is produced from ethylene propylene diene monomer rubber (EPDM).
